(19) United States
(12) Patent Application Publication
(10) Pub. No.: US 2026/0331759 A1
(43) Pub. Date: Oct. 22, 2026

(54) Method for Antenna or Remote Sensing Performance via Application of Physical Principle

(71) Applicant: NORTHROP GRUMMAN SYSTEMS CORPORATION, FALLS CHURCH, VA (US)

(72) Inventors: Alex N. Jensen, Falls Church, VA (US); Charles L. Chidester, Falls Church, VA (US); Ryan M. McLaughlin, Falls Church, VA (US)

(21) Appl. No.: 19/180,700

(22) Filed: Apr. 16, 2025

(51) Int. Cl. H01Q 1/42; H01Q 15/02; H01Q 21/06

(52) U.S. Cl. CPC H01Q 1/422; H01Q 15/02; H01Q 21/061

(57) ABSTRACT

A radio frequency (RF) antenna system including an antenna, a first dielectric layer formed over the antenna, and a second dielectric layer formed over the first dielectric layer. The index of refraction and/or the thickness of the second dielectric layer are selected so that the portion of a transmitted RF signal transmitted by the antenna that is reflected off of the interface between the first and second dielectric layers and the portion of the transmitted RF signal that is reflected off of the interface between the second dielectric layer and a propagation medium and propagates into the first dielectric layer are 180° out of phase and destructively interfere with each other to maximize radiated power from the antenna.

### BACKGROUND

### Field

This disclosure relates generally to an antenna and, more particularly, to a phased array antenna including two dielectric layers configured to cancel reflected beam power.

### Discussion of the Related Art

Various systems employ antennas for transmitting and receiving RF signals, for example, systems used for remote sensing. Some of those antennas are phased array antennas that include an array of antenna elements that are electronically controlled through beamforming to change the phase of each element beam so that they constructively interfere with each other. This allows the combined beam to be steered in a desirable direction. Antennas can be mounted to a variety of platforms and can be covered or embedded in a non-conductive or dielectric material. For example, radar systems often employ phased array antennas that are covered by a radome. Also, in some applications, it may be desirable to flush mount the antenna to the ground or other surface so that it is less detectable.

Radio waves propagate at different speeds in different materials. The speed of a wave in a medium relative to the speed of the wave in a vacuum defines the index of refraction of the medium. The change in the index of refraction of a wave travelling from one medium to another medium causes the wave to bend. Also, a portion of the wave is reflected at the interface between the mediums having different indexes of refraction, which causes some of the power of the wave to be lost. The larger the index of refraction between the mediums the more the wave bends and more of the wave is reflected. For some antenna orientations, it is desirable to use the change in the index of refraction between mediums as a way to steer a transmitted beam to side areas that wouldn't be possible with just phased array steering to enhance the maximum angle of energy emission relative to the antenna surface normal. The reflected portion of the beam is either dissipated as heat or is picked up by the antenna. Thus, there is a tradeoff between steering the beam and loss of beam power, and unwanted feedback.

### BRIEF DESCRIPTION OF THE DRAWINGS

FIG. 1 is an illustration of a known antenna system including a phased array antenna covered by a dielectric layer and showing beam interaction at an interface between the dielectric layer and air; and

FIG. 2 is an illustration of an antenna system including a phased array antenna covered by two dielectric layers having different indexes of refraction and showing beam interaction at an interface between the first dielectric layer and the second dielectric layer, and the second dielectric layer and air.

### DETAILED DESCRIPTION OF THE EMBODIMENTS

The following discussion of the embodiments of the disclosure directed to a phased array antenna including two dielectric layers configured to cancel reflected beam power is merely exemplary in nature, and is in no way intended to limit the disclosure or its applications or uses.

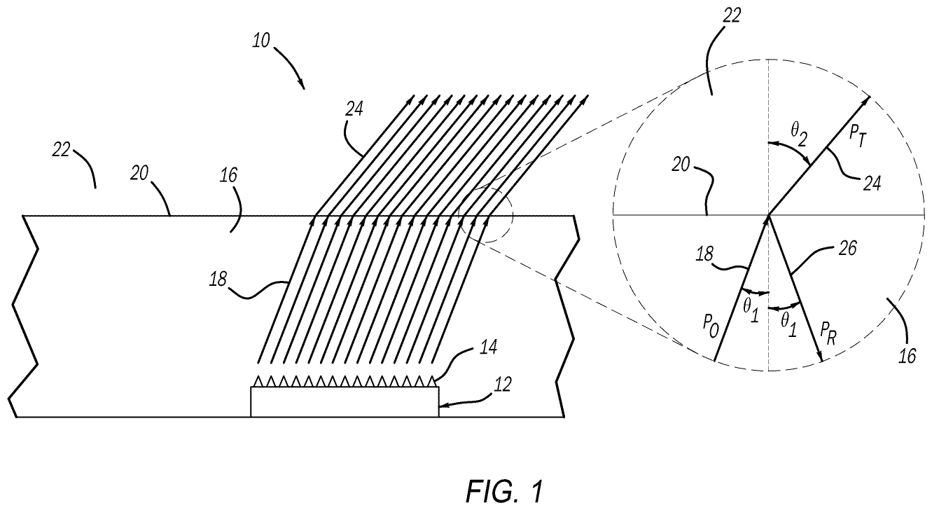

FIG. 1 is an illustration of a known antenna system 10 including a phased array antenna 12 having an array of antenna elements 14. The antenna 12 is covered by a dielectric layer 16 that is transparent to a radio frequency (RF) beam 18 emitted from each of the antenna elements 14. The antenna system 10 is intended to represent any antenna system operating at any radio frequency and mounted to any platform suitable for the purposes discussed herein, where the material of the dielectric layer 16 can be any suitable material. All of the necessary beamforming electronics and components are provided in the antenna 12 whose operation would be well understood by those skilled in the art. It is noted that although the discussion herein refers to beam transmission and a phased antenna array, the concepts described herein will be applicable for beam receiving and individual antennas or antenna elements of any suitable configuration. The dielectric layer 16 can be a protective coating, such as an epoxy, formed over the antenna 12 and the antenna elements 14 in any suitable thickness or configuration for any suitable application. It is noted that the thickness of the dielectric layer 16 is not to scale relative to other shown components in that the antenna 12 is typically many times larger that the dielectric layer 16.

Each beam 18 propagates through the dielectric layer 16 at a certain beam steered angle and is refracted at an interface 20 between the dielectric layer 16 and a propagation medium 22, such as air, at an angle θ₂ from the interface 20 relative to normal, i.e., perpendicular to the interface 20. The amount of refraction of the beam 18 depends on the index of refraction n₁ of the dielectric layer 16, the index of refraction n₂ of the medium 22 and the angle θ₁ that the beam 18 impinges the interface 20 relative to normal, where n₁=\sqrt{εᵣ₁μᵣ₁}, n₂=\sqrt{εᵣ₂μᵣ₂}, ε is the permittivity of the material and μ is the permeability of the material. From Snell's Law, n₁ (sin θ₁)=n₂ (sin θ₂). Pₒ is the RF power of the beam 18 propagating in the dielectric layer 16, P_{T} is the RF power of a transmitted beam 24 propagating in the medium 22, and P_{R} is the RF power of a reflected beam 26 that is reflected off of the interface 20 when the beam 18 impinges the interface 20.

The index of refraction n₂ of the medium 22 is greater than the index of refraction n₁ of the dielectric layer 16, where the larger the difference in the indexes of refraction the greater the angle θ₂, which may be desirable for low look angles in certain applications. However, as mentioned above, the greater the angle θ₂, the larger the reflected RF power P_{R} shown by the reflected beam 26, which is typically undesirable because it reduces the transmitted power P_{T}.

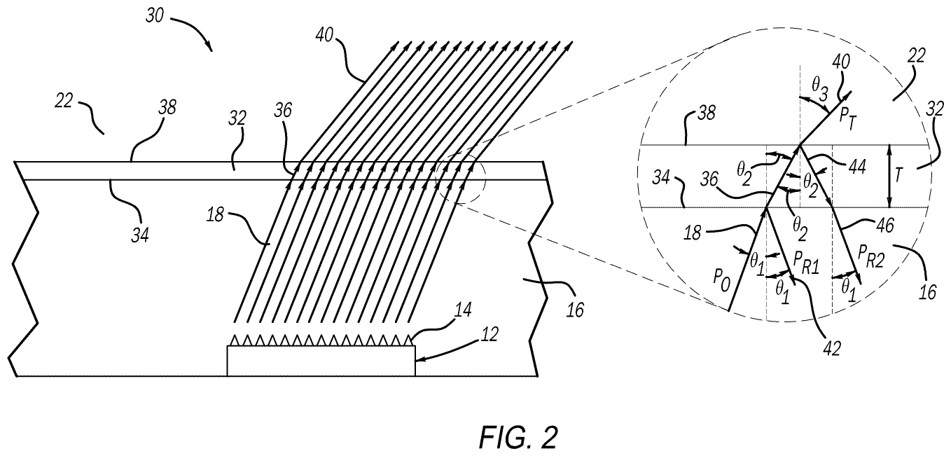

FIG. 2 is an illustration of an antenna system 30 that addresses this power/angle tradeoff, where like elements to the antenna system 10 in FIG. 1 are identified by the same reference number. The antenna system 30 includes a surface dielectric layer 32 formed on the dielectric layer 16 that has a greater index of refraction n₃ than the index of refraction n₂ of the dielectric layer 16, where n₃=\sqrt{εᵣ₃μᵣ₃}, and where the material of the dielectric layer 32 can be any suitable material that satisfies this requirement and is RF transparent. The inclusion of the dielectric layer 32 creates an interface 34 between the dielectric layers 16 and 32, and an interface 38 between the dielectric layer 32 and the medium 22. An intermediate beam 36 propagates through the dielectric layer 32 at an angle θ₂ relative to normal from the interface 34 and a transmitted beam 40 propagates through the medium 22 at an angle θ₃ from the interface 38 relative to normal. From Snell's Law, n₂ (sin θ₂)=n₃ (sin θ₃) and n₁ (sin θ₁)=n₃ (sin θ₃).

A reflected beam 42 is reflected off of the interface 34 when the beam 18 impinges the interface 34 and has an RF power P_{R1}. A reflected beam 44 is reflected off of the interface 38 when the beam 36 impinges the interface 38, propagates through the dielectric layer 32 and into the dielectric layer 16 as beam 46 having RF power P_{R2}. The difference in the path length ΔL of the beam 36 and the beam 44 propagating through the layer 32 is given by:

$$Δ L = \frac{2 T}{cos ( {θ}_{2} )} = \frac{λ}{2} ,$$

where λ is the wavelength of the beams 36 and 44 that is determined by the index of refraction n₂ of the layer 32 and T is the thickness of the layer 32.

The thickness T can be solved by the above equation as:

T=λ*cos(θ₂).

By properly selecting the thickness T and/or the material, and thus the index of refraction n₂, of the dielectric layer 32 relative to the material, and thus the index of refraction n₁, of the dielectric layer 16, the phase of the beam 46 can be made to be 180° out of phase with the phase of the beam 42 so that the beams 42 and 46 destructively interfere with each other and the RF powers P_{R1} and P_{R2} will cancel, thus removing the reflected beam power. Hence, the RF power P_{T} will be the same or nearly the same as the RF power P₀. Therefore, by adding the specially designed dielectric layer 32, the size, complexity, cost, etc. of the antenna 12 can be reduced without loss of performance. In other words, large differences in the indexes of refraction of the layers 16 and 32 can be provided to achieve low propagation angles of the transmitted beam 40 without loss of power and undesirable feedback.

As is apparent, the thickness T of the layer 32 is based on the wavelength λ of the beam 36 propagating through the layer 32, and therefore there are practical limitations as how low the frequency of the beam 18 can be. As such, RF frequencies above 1 GHz may be applicable. Further, the thickness T and the material of the layer 32 may need to be adjusted across the antenna 12 in the x-direction so that proper beam steering is maintained for all of the beams 18.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

1. A radio frequency (RF) antenna system comprising:
an antenna operable to transmit and receive RF signals;
a first dielectric layer transparent to RF signals and formed over and in contact with the antenna and having a first index of refraction; and
a second dielectric layer transparent to RF signals and formed over and in contact with the first dielectric layer so as to create a first interface therebetween, said second dielectric layer creating a second interface with a propagation medium opposite to the first interface, said second dielectric layer having a second index of refraction that is larger than the first index of refraction and smaller than an index of refraction of the medium, wherein an RF signal transmitted by the antenna propagates through the first dielectric layer and impinges the first interface so that a portion of the transmitted RF signal is reflected off of the first interface back into the first dielectric layer, a portion of the transmitted RF signal propagates through the second dielectric layer and is reflected off of the second interface back into the second dielectric layer and into the first dielectric layer, and a portion of the transmitted RF signal propagates into the propagation medium, and wherein the second index of refraction and/or a thickness of the second dielectric layer are selected so that the portion of the transmitted RF signal that is reflected off of the first interface and the portion of the transmitted RF signal that is reflected off of the second interface and propagates into the first dielectric layer are 180° out of phase and destructively interfere with each other.

2. The antenna system according to claim 1 wherein the antenna is a phased array antenna.

3. The antenna system according to claim 1 wherein the first dielectric layer is a protective layer.

4. The antenna system according to claim 1 wherein an RF power of the transmitted RF signal is about the same as an RF power of the portion of the transmitted RF signal that propagates into the medium.

5. The antenna system according to claim 1 wherein the second dielectric layer is also selected to provide a desired beam steering angle of the portion of the transmitted RF signal that propagates in the medium.

6. The antenna system according to claim 1 wherein the frequency of the transmitted RF signal is above 1 GHz.

7. A phased array antenna comprising:
a plurality of antenna elements each being operable to transmit RF signals;
a first dielectric layer transparent to RF signals and formed over and in contact with the antenna elements and having a first index of refraction; and
a second dielectric layer transparent to RF signals and formed over and in contact with the first dielectric layer so as to create a first interface therebetween, said second dielectric layer creating a second interface with a propagation medium opposite to the first interface, said second dielectric layer having a second index of refraction that is larger than the first index of refraction and smaller than an index of refraction of the medium, wherein an RF signal transmitted by each antenna element propagates through the first dielectric layer and impinges the first interface so that a portion of the transmitted RF signal is reflected off of the first interface back into the first dielectric layer, a portion of the transmitted RF signal propagates through the second dielectric layer and is reflected off of the second interface back into the second dielectric layer and into the first dielectric layer, and a portion of the transmitted RF signal propagates into the propagation medium, and wherein the second index of refraction and/or a thickness of the second dielectric layer are selected so that the portion of the transmitted RF signal that is reflected off of the first interface and the portion of the transmitted RF signal that is reflected off of the second interface and propagates into the first dielectric layer are 180° out of phase and destructively interfere with each other.

8. The antenna according to claim 7 wherein an RF power of the transmitted RF signal is about the same as an RF power of the portion of the transmitted RF signal that propagates in the medium.

9. The antenna according to claim 7 wherein the second dielectric layer is also selected to provide a desired beam steering angle of the portion of the transmitted RF signal that propagates in the medium.

10. The antenna according to claim 7 wherein the frequency of the transmitted RF signal is above 1 GHz.

11. A radio frequency (RF) antenna system including an antenna, a first dielectric layer formed over and in contact with the antenna, and a second dielectric layer formed over and in contact with the first dielectric layer, wherein an index of refraction and/or thickness of the second dielectric layer are selected so that a portion of a transmitted RF signal transmitted by the antenna that is reflected off of an interface between the first and second dielectric layers and a portion of the transmitted RF signal that is reflected off of an interface between the second dielectric layer and a propagation medium and propagates into the first dielectric layer are 180° out of phase and destructively interfere with each other.

12. The antenna system according to claim 11 wherein the antenna is a phased array antenna.

13. The antenna system according to claim 11 wherein the first dielectric layer is a protective layer.

14. The antenna system according to claim 11 wherein an RF power of the transmitted RF signal is about the same as an RF power of the portion of the transmitted RF signal that propagates in the medium.

15. The antenna system according to claim 11 wherein the second dielectric layer is also selected to provide a desired beam steering angle of the portion of the transmitted RF signal that propagates in the medium.

16. The antenna system according to claim 11 wherein the frequency of the transmitted RF signal is above 1 GHZ.
